(19) United States
(12) Patent Application Publication
(10) Pub. No.: US 2026/0302084 A1
(43) Pub. Date: Oct. 1, 2026

(54) ABLATED MONOLITHIC DIAMOND CAPACITOR WITH ELECTRODES

(71) Applicant: Medtronic, Inc., Minneapolis, MN (US)

(72) Inventors: Mark E. Viste, Brooklyn Center, MN (US); Steven J. May, Minnetonka, MN (US); Jimmy L. Davidson, Brentwood, TN (US); Christian S. Nielsen, River Falls, WI (US); John Fraley, Fayetteville, AR (US); Travis Wade, Harvard, MA (US); David V. Kerns, JR., Nashville, TN (US); Glenn Hess, Satellite Beach, FL (US)

(21) Appl. No.: 19/574,634

(22) Filed: Mar. 23, 2026

Related U.S. Application Data
(60) Provisional application No. 63/778,810, filed on Mar. 27, 2025.

(51) Int. Cl. H01G 4/30; H01G 4/008; H01G 4/12

(52) U.S. Cl. CPC H01G 4/30; H01G 4/008; H01G 4/1209

(57) ABSTRACT

Capacitors and methods of making the same are provided. The capacitors may include a monolithic diamond body with electrodes of electrically conductive material therein. The electrodes of electrically conductive material may be separated by a dielectric diamond layer of the monolithic diamond body. The electrodes may be formed by ablating regions of the monolithic diamond body using a laser and introducing electrically conductive material into the ablated regions.

### RELATED APPLICATIONS

This application claims the benefit of U.S. Provisional Application Ser. No. 63/778,810, filed Mar. 27, 2025, the entire contents of each of which are incorporated herein by reference.

### TECHNICAL FIELD

This disclosure generally relates to, among other things, capacitors and, more particularly, to diamond capacitors.

### BACKGROUND

In general, there is a need for capacitor technology that can provide high voltage and high energy density. Such capacitor technology may be useful in a variety of applications and fields, such as in medical, industrial, and military applications, for just a few examples. As another example, such capacitor technology may be useful in implantable medical devices (such as cardioverter-defibrillators).

Therapeutic electrical pulse delivery systems and apparatuses generally use capacitors to store energy and deliver a therapeutic pulse or shock to a patient. Capacitors may store energy in an electric field between two electrodes (e.g., a first electrode and a second electrode). Capacitors may charge and discharge stored energy more rapidly than batteries or other power sources. Additionally, capacitors can operate at a higher voltage than batteries or other power sources of a similar size. In other words, capacitors may generally be described as having a higher power density than other power sources. Accordingly, capacitors may be used to provide high-voltage pulses or shocks in therapeutic electrical pulse delivery systems and apparatuses.

In a lab or hospital setting, the size, shape, weight, and durability of capacitors in therapeutic electrical pulse delivery systems may not be significant. However, size, shape, weight, and durability of capacitors are important design considerations for therapeutic electrical pulse delivery systems designed to be implanted in or worn by a patient. Large or bulky capacitors and capacitor housings may increase the size and weight of implantable and wearable devices. Furthermore, capacitors may be subject to mechanical or electromechanical deformation that can affect the operation of therapeutic electrical pulse delivery systems and apparatuses over time. Thus, capacitors and pulse generators that can deliver high voltage, high-energy therapeutic pulses in a small, lightweight form factor with high durability may be desirable.

### SUMMARY

As described herein, capacitors suitable for small, lightweight form factors and increased durability can be achieved using a monolithic diamond body having capacitor unit cells formed therein by focusing electromagnetic radiation into the monolithic diamond body, to thereby ablate the diamond, and disposing electrically conductive material, such as metallic electrically conductive material, into the ablated region. Such capacitors may reduce the mass and volume required to achieve a given capacitance. Additionally, monolithic diamond capacitors may be designed in many different form factors and may be less susceptible to electromechanical deformation and degradation.

Embodiments disclosed herein may include a capacitor having a monolithic diamond body, a first electrode extending from a first electrode contact region at an outer surface of the monolithic diamond body into the monolithic diamond body, a second electrode extending from a second electrode contact region at the outer surface of the monolithic diamond body into the monolithic diamond body, and a dielectric diamond layer of the monolithic diamond body separating the first electrode and the second electrode. The first electrode includes electrically conductive material disposed within a first ablated region defined by the monolithic diamond body. The second electrode includes electrically conductive material.

Embodiments disclosed herein may further include a capacitor having a monolithic diamond body and a plurality of capacitor unit cells, each unit cell including a first electrode, a second electrode, and a dielectric diamond layer of the monolithic diamond body separating the first electrode and the second electrode. The first electrode includes electrically conductive material disposed within a first ablated region defined by the monolithic diamond body and extending from a first electrode contact region at an outer surface of the monolithic diamond body into the monolithic diamond body. The second electrode includes electrically conductive material disposed within a second ablated region defined by the monolithic diamond body and extending from a second electrode contact region at an outer surface of the monolithic diamond body into the monolithic diamond body.

Embodiments disclosed herein may still further include a method for manufacturing a capacitor, the method including forming a first electrode within a monolithic diamond body and forming a second electrode within the monolithic diamond body, the second electrode separated from the first electrode by a dielectric diamond layer of the monolithic diamond body. Forming the first electrode includes focusing electromagnetic radiation into the monolithic diamond body to ablate a region of the monolithic diamond body, thereby forming a first ablated region defined by the monolithic diamond body; and disposing electrically conductive material in the first ablated region.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a cross-section side view of an illustrative capacitor having one unit cell.

FIG. 2 is a cross-section side view of an illustrative capacitor having three capacitor unit cells.

FIG. 3A is a cross-section side view of an illustrative capacitor having a plurality of unit cells.

FIG. 3B is a perspective view of the illustrative capacitor of FIG. 3A.

FIG. 4A is a cross-section top view of an illustrative cylindrical capacitor.

FIG. 4B is a cross-section side view of the illustrative cylindrical capacitor of FIG. 4A.

FIG. 5A is a cross-section side view of an illustrative capacitor having wedge-shaped electrodes.

FIG. 5B is a cross-section top view of the illustrative capacitor of FIG. 5A.

FIGS. 6A-C are cross-section top views of illustrative ring-shaped capacitors.

FIGS. 7A-7C show an illustrative capacitor with electrode contact regions each having widths approximately equal to widths of respective electrodes in a cross-section side view (FIG. 7A) and in cross-section front views (FIGS. 7B and 7C).

FIGS. 8A-8C show an illustrative capacitor with electrode contact regions each having widths less than widths of respective electrodes in a cross-section side view (FIG. 8A) and in cross-section front views (FIGS. 8B and 8C).

FIGS. 9A and 9B show an illustrative capacitor with electrode contact regions not co-planar with respective electrodes in a cross-section side view (FIG. 9A) and in a schematic top view (FIG. 9B).

FIG. 10 is a cross-section side view of an illustrative capacitor with electrode connectors.

FIG. 11 is a cross-section side view of an illustrative capacitor apparatus including the capacitor of FIG. 10 electrically connected to another capacitor via one of the electrode connectors of FIG. 10.

FIG. 12A is a flow diagram of an illustrative method of making an electrode, such as an electrode of the capacitor of FIGS. 3A and 3B.

FIG. 12B is a flow diagram of an illustrative method of making a capacitor, such as the capacitor of FIGS. 3A and 3B.

FIGS. 13A-13D, 14A, and 14B are diagrams illustrating aspects of the illustrative methods of FIGS. 12A and 12B.

The figures are rendered primarily for clarity and, as a result, are not necessarily drawn to scale. Moreover, various structure/components may be shown diagrammatically or removed from some or all of the views to better illustrate aspects of the depicted embodiments, or where inclusion of such structure/components is not necessary to an understanding of the various illustrative embodiments described herein. The lack of illustration/description of such structures/components in a particular figure is, however, not to be interpreted as limiting the scope of the various embodiments in any way.

### DETAILED DESCRIPTION

All scientific and technical terms used herein have meanings commonly used in the art unless otherwise specified. The definitions provided herein are to facilitate understanding of certain terms used herein and are not meant to limit the scope of the present disclosure.

Unless otherwise indicated, the terms “polymer”, “polymerized monomers”, and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

In this disclosure, all numbers are assumed to be modified by the term “about,” which encompasses the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. The terms “and/or” and “any combination thereof” and their grammatical equivalents as used herein, can be used interchangeably. These terms can convey that any combination is specifically contemplated. Solely for illustrative purposes, the following phrases “A, B, and/or C” or “A, B, C, or any combination thereof” can mean “A individually; B individually; C individually; A and B; B and C; A and C; and A, B, and C.” The term “or” can be used conjunctively or disjunctively unless the context specifically refers to a disjunctive use.

The recitations of numerical ranges by endpoints include all numbers subsumed within that range (e.g., 1 to 5 includes 1, 1.5, 2, 2.75, 3, 3.80, 4, 5, etc., or 10 or less includes 10, 9.4, 7.6, 5, 4.3, 2.9, 1.62, 0.3, etc.). Where a range of values is “up to”, “at most”, or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. It is contemplated that any embodiment discussed in this specification can be implemented with respect to any method or composition of the present disclosure, and vice versa. Furthermore, compositions of the present disclosure can be used to achieve methods of the present disclosure. Such inclusive or open-ended words encompass more restrictive or closed terms or phrases, such as “consisting” or “consisting essentially.”

As used herein, “consisting essentially of” means that the article or method consisting essentially of listed elements may include additional elements that do not materially affect the basic and novel characteristics of the article or method.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

Reference in the specification to “some embodiments,” “an embodiment,” “one embodiment,” “embodiments,” “one or more embodiments,” “at least one embodiment,” or “other embodiments” means that a particular feature, structure, or characteristic described in connection with the embodiments is included in at least some embodiments, but not necessarily all embodiments, of the present disclosures.

Any direction referred to herein, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

In several places throughout the application, guidance is provided through examples, which examples, including the particular aspects thereof, can be used in various combinations and be the subject of claims. In each instance, the recited list serves only as a representative group and should not be interpreted as an exclusive list. It is to be understood that the particular examples, materials, amounts, and procedures are to be interpreted broadly in accordance with the scope and spirit of the invention as set forth herein.

Reference will now be made in greater detail to various embodiments of the subject matter of the present disclosure, one or more embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same as or similar to other numbered components.

As described herein, capacitors suitable for small, lightweight form factors and increased durability can be achieved using a monolithic diamond body having capacitor unit cells formed therein by focusing electromagnetic radiation into the monolithic diamond body, to thereby ablate the diamond, and introducing electrically conductive material into the ablated region. Such capacitors may reduce the mass and volume required to achieve a given capacitance. That is to say, such capacitors may have improved energy density, improved power density, or both. Additionally, monolithic diamond capacitors may be designed in many different form factors and may be less susceptible to electromechanical deformation and degradation.

As described herein, a diamond capacitor may be formed using a monolithic diamond substrate by forming electrodes within the diamond substrate. The electrodes may be formed within the diamond substrate, for example, by selectively ablating regions of the diamond substrate and disposing, or introducing, electrically conductive material into the ablated region. Using focused electromagnetic radiation, ablated regions may be formed in the diamond substrate, into which electrically conductive material may be disposed to establish electrodes of the diamond capacitor. The electrodes may be separated by layers of native (e.g., unablated) diamond substrate to establish one or more dielectric layers of the diamond capacitor. Diamond may be described as having a high dielectric strength, allowing energy to be stored in capacitors at higher voltage with reduced volume of dielectric compared to other dielectric materials, such as in electrolytic capacitors. Thus, individual diamond capacitors may also be smaller than individual electrolytic capacitors and still operate at a higher voltage than electrolytic capacitors, as an example.

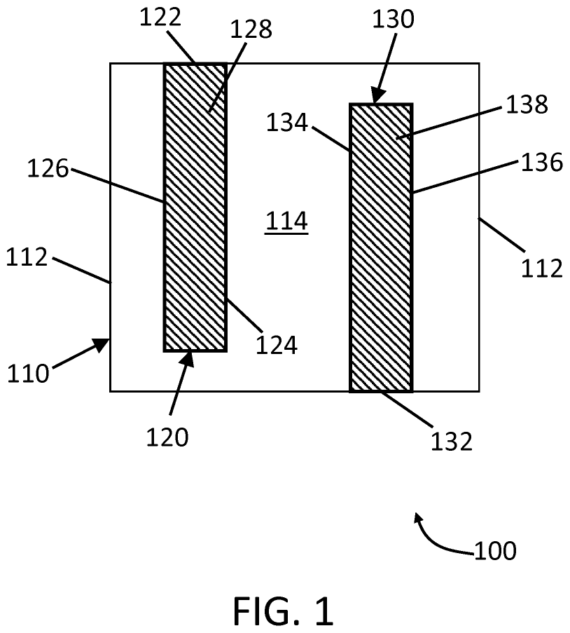

A cross-section side view of an illustrative capacitor 100 is shown in FIG. 1. In one or more embodiments, the capacitor 100 includes a monolithic diamond body 110 having an outer surface 112 (e.g., one or more outer surfaces) and first and second electrodes 120, 130 within the monolithic diamond body 110. Each electrode may be, or include, electrically conductive material disposed within the monolithic diamond body 110 and, in particular, within a respective ablated region defined by the monolithic diamond body 110, which may extend from a respective electrode contact region at the outer surface 112 of the monolithic diamond body 110 into the monolithic diamond body 110. For example, the first electrode 120 may include electrically conductive material 128 disposed within a first ablated region 126 defined by the monolithic diamond body 110 and extending from a first electrode contact region 122 at the outer surface 112 of the monolithic diamond body 110 into the monolithic diamond body 110.

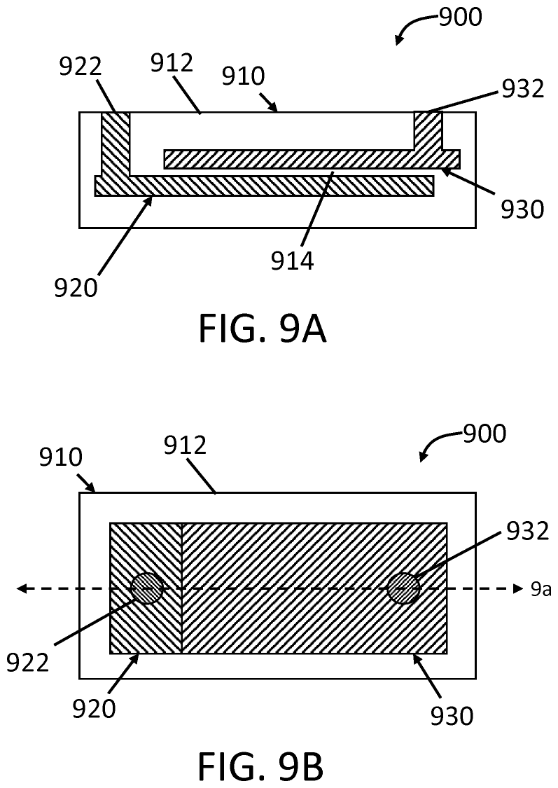

The first electrode 120 may extend from the first electrode contact region 122 at the outer surface 112 of the monolithic diamond body 110 into the monolithic diamond body 110. The first electrode 120 may define a plane or an axis. The first electrode contact region 122 may define a plane or an axis, which may be co-planar or co-axial with the plane or the axis defined by the first electrode 120. Additionally or alternatively, the plane or axis defined by the first electrode contact region 122 may be not co-planar, not co-axial, or neither co-planar nor co-axial with the plane defined by the first electrode 120 (see FIGS. 9A and 9B, for example). The first electrode 120 may have a polarity, such as a positive polarity or a negative polarity.

As described herein, and with continued reference to FIG. 1, the illustrative capacitor 100 may further include the second electrode 130 including electrically conductive material 138. In one or more embodiments, the second electrode 130 extends from a second electrode contact region 132 at the outer surface 112 of the monolithic diamond body 110 into the monolithic diamond body 110. In some embodiments, the electrically conductive material 138 of the second electrode 130 is disposed within a second ablated region 136 defined by the monolithic diamond body 110 and extending from the second electrode contact region 132 at the outer surface 112 of the monolithic diamond body 110 into the monolithic diamond body 110. The second electrode 130 may define a plane or an axis, which may be parallel to the plane or the axis of the first electrode 120. The second electrode 130 may have a polarity, such as a negative polarity or a positive polarity. The second electrode 130 may have a polarity opposite the polarity of the first electrode 120.

In one or more embodiments, a dielectric diamond layer 114 of the monolithic diamond body 110 separates the first electrode 120 and the second electrode 130. The dielectric diamond layer 114 may be described as separating capacitive interface regions 124, 134 of the first electrode 120 and the second electrode 130, respectively. The illustrative capacitor 100 may be described as having one capacitor unit cell. In other words, the illustrative capacitor 100 may be described as including one dielectric diamond layer 114 separating two electrodes 120, 130, thereby establishing one capacitor unit cell.

The electrically conductive material of each electrode (e.g., the electrically conductive material 128 of the first electrode 120) may be, or include, any suitable electrically conductive material. Suitable electrically conductive materials may be selected based on factors such as electrical conductivity, thermal conductivity, material compatibility (e.g., with the monolithic diamond body 110), melting point, or desired method of assembly (e.g., the desired method of disposing (e.g., introducing) the electrically conductive material 128 into the first ablated region 126), as a few examples. As another example, suitable electrically conductive materials may be selected based on material compatibility with other electrically conductive materials of the capacitor, such as electrode connectors or different electrically conductive materials of the same electrode. Material compatibility may include factors such as contact resistance between the materials or adhesion between the materials. In some embodiments, suitable electrically conductive materials may be selected based on material compatibility with ablated carbon redeposited in the ablated region (described further herein). For example, the electrical properties of some electrically conductive materials (such as carbide forming metals) may be relatively less affected by redeposited carbon in the ablated region. Furthermore, redeposited carbon in the ablated region may advantageously wick liquid electrically conductive material (e.g., molten metals) into the ablated region.

In one or more embodiments, suitable electrically conductive materials are selected based on material compatibility with diamond, such as the material's ability to wet diamond. The capability of an electrically conductive material to wet diamond may be described as the capability of the material and the diamond to form a stable interface therebetween. Selecting a more strongly-wetting electrically conductive material (e.g., a metal, such as titanium) may advantageously improve mechanical interface between the electrically conductive material and the diamond, which may be advantageous, for example, to more easily dispose the electrically conductive material within the ablated region to form the electrode. Further, wetting capability may include the capability of the electrically conductive material and the diamond to form an interfacial zone therebetween, which may afford some doping character, such as p-doping character or n-doping character. Without wishing to be bound by theory, the operational voltage of an illustrative diamond capacitor described herein may advantageously be increased by selecting a more strongly-wetting electrically conductive material. However, and still without wishing to be bound by theory, selecting a more strongly-wetting electrically conductive material may result in the interface between the electrically conductive material and the diamond having a greater barrier to charge carriers being liberated and available to move across the dielectric, which may result in breakdown. In some embodiments, a less strongly-wetting (e.g., non-wetting) electrically conductive material (e.g., a less strongly-wetting metal, such as copper, silver, or gold) may be selected, for example, to afford a less complex electronic structure, which may be advantageous, for example, to reduce (e.g., minimize) breakdown.

In some embodiments, suitable electrically conductive materials include metals (e.g., metal alloys). For example, suitable electrically conductive materials may include aluminum, gallium, mercury, copper, silver, gold, platinum, titanium, or any combination (e.g., alloy) thereof.

Suitable electrically conductive materials may include conductive carbon. In some embodiments, at least one electrode may include an electrically conductive carbon region comprising conductive carbon. The electrically conductive carbon region may be defined by and formed within the monolithic diamond body 110, as described further below. For example, the first electrode 120 may include an electrically conductive carbon region adjacent to and in contact with the first ablated region 126. Additionally or alternatively, portions of the first electrode 120 defined by the first ablated region 126 may be formed by an electrically conductive carbon region. In other words, the first electrode 120 may be formed by various combinations of one or more ablated regions defined by the monolithic diamond body with electrically conductive material disposed therein and one or more electrically conductive carbon regions formed in the monolithic diamond body.

Any suitable form of conductive carbon may be used. Suitable forms of conductive carbon may be described as electrically conductive carbon allotropes, such as non-diamond carbon allotropes. Suitable forms of conductive carbon may include carbon allotropes having an sp² hybridized orbital, as an example. As another example, suitable forms of conductive carbon may include conductive allotropes of carbon formed by thermolysis of diamond. Further examples of conductive carbon may include graphene, graphite, carbon nanotubes, amorphous carbon, and any combination thereof.

In one or more embodiments, conductive carbon may be characterized based on resistivity. Conductive carbon may be characterized by any suitable resistivity. Suitable conductive carbon resistivities may be, or include, for example, 2 microohms per meter (uO/m) to 3,000 uO/m, 500 uO/m to 800 uO/m, or 2.5 uO/m to 5 uO/m. Suitable conductive carbon resistivities may additionally or alternatively be, or include, 5,000 uO/m or less, 500 uO/m or less, 50 uO/m or less, or 5 uO/m or less.

In some embodiments, conductive carbon may additionally or alternatively be characterized based on conductivity. Conductive carbon may be characterized by any suitable conductivity. Suitable conductive carbon conductivities may include 1 Siemens per meter (S/m) to 300,000 S/m, 200 S/m to 2,000 S/m, or 2 S/m to 300,000 S/m, as examples. Suitable conductive carbon conductivities may additionally or alternatively include 1 S/m or greater, 100 S/m or greater, 1,000 S/m or greater, 10,000 S/m or greater, or 100,000 S/m or greater.

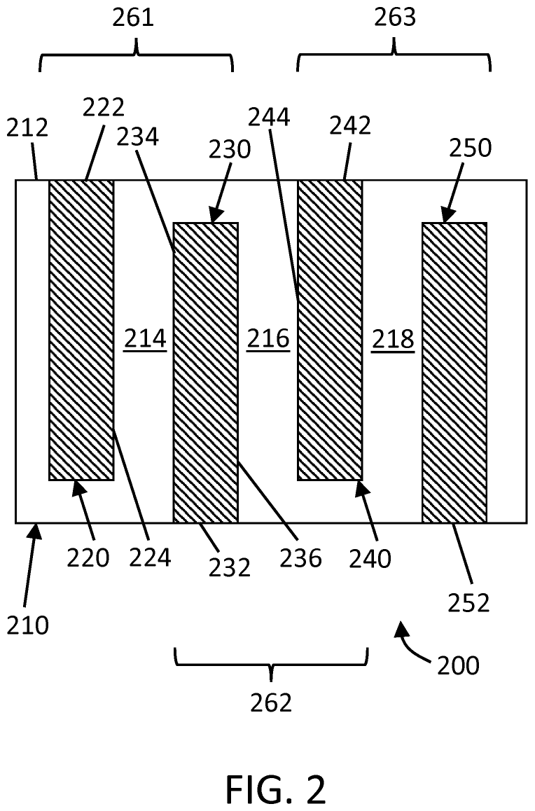

In one or more embodiments, capacitors described herein include a plurality of capacitor unit cells. A cross-section side view of an illustrative capacitor 200 having three capacitor unit cells is shown in FIG. 2. The capacitor 200 may include a monolithic diamond body 210 having an outer surface 212 (e.g., one or more outer surfaces). The capacitor 200 further includes a first electrode 220, a second electrode 230, a third electrode 240, and a fourth electrode 250, each extending from a respective electrode contact region 222, 232, 242, 252 at the outer surface 212 and into the monolithic diamond body 210. Each electrode 220, 230, 240, 250 may define a plane or an axis.

The second electrode 230 may extend from the second electrode contact region 232 at the outer surface 212 and into the monolithic diamond body 210. The second electrode 230 may define a plane or an axis, which may be parallel to the plane or the axis defined by the first electrode 220. Each of the first and second electrodes 220, 230 may have a polarity. The first electrode 220 may have a polarity opposite the polarity of the second electrode 230. A dielectric diamond layer 214 of the monolithic diamond body 210 may separate the first electrode 220 and the second electrode 230. The dielectric diamond layer 214 may be described as separating capacitive interface regions 224, 234 of the first electrode 220 and the second electrode 230, respectively. The first and second electrodes 220, 230 and the first dielectric diamond layer 214 therebetween may be described as establishing a first capacitor unit cell 261.

The third electrode 240 may extend from the third electrode contact region 242 at the outer surface 212 and into the monolithic diamond body 210. The third electrode 240 may define a plane or an axis, which may be parallel to the plane or the axis defined by the first electrode 220. The plane or the axis defined by the third electrode 240 may additionally or alternatively be parallel to the plane or the axis defined by the second electrode 230. The third electrode 240 may have a polarity. The third electrode 240 may have a polarity opposite the polarity of the second electrode 230. A second dielectric diamond layer 216 may separate the third electrode 240 and the second electrode 230. The second dielectric diamond layer 216 may be described as separating capacitive interface regions 236, 244 of the second electrode 230 and the third electrode 240, respectively. The second and third electrodes 230, 240 and the second dielectric diamond layer 216 therebetween may be described as establishing a second capacitor unit cell 262.

The fourth electrode 250 may extend from the fourth electrode contact region 252 at the outer surface 212 and into the monolithic diamond body 210. The fourth electrode 250 may define a plane or an axis, which may be parallel to the plane or the axis defined by the third electrode 240. The plane or the axis defined by the fourth electrode 250 may additionally or alternatively be parallel to each or any of the planes or the axes defined by the first electrode 220 and the second electrode 230. The fourth electrode 250 may have a polarity. The fourth electrode 250 may have a polarity opposite the polarity of the third electrode 240. A third dielectric diamond layer 218 may separate the fourth electrode 250 and the third electrode 240. The third and fourth electrodes 240, 250 and the third dielectric diamond layer 218 therebetween may be described as establishing a third capacitor unit cell 263. In one or more embodiments, the capacitor 200 may be described as having interdigitated electrodes 220, 230, 240, 250 with alternating polarities. Each opposite-polarity pair of electrodes and the dielectric diamond layer therebetween may be described as establishing a respective capacitor unit cell.

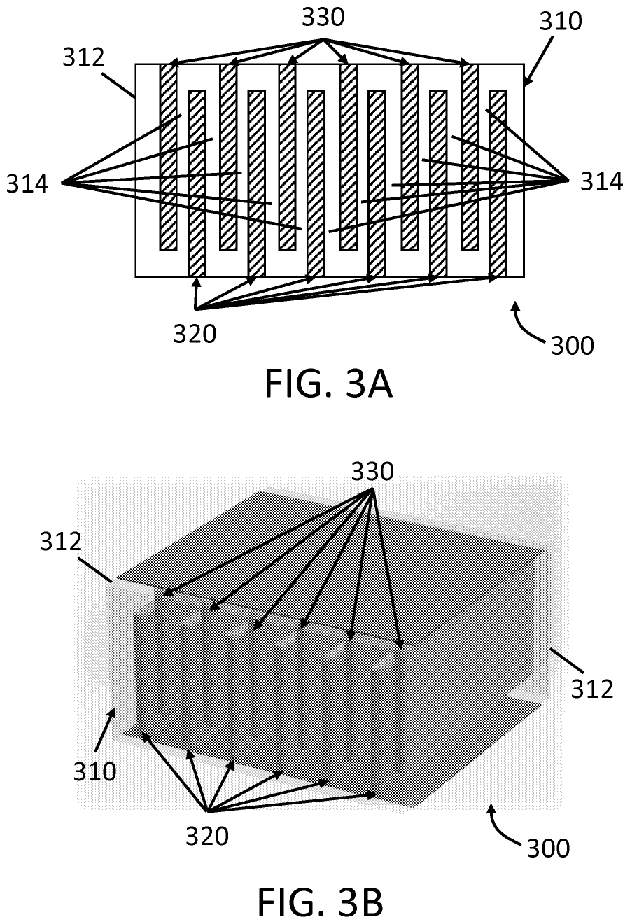

Still another illustrative capacitor 300 with a plurality of unit cells is shown in cross-section side view in FIG. 3A and in perspective view in FIG. 3B. The plurality of unit cells may be established by a plurality of dielectric diamond layers 314 separating a plurality of interdigitated first electrodes 320 and second electrodes 330 extending from respective electrode contact regions at an outer surface 312 (e.g., one or more outer surfaces) of a monolithic diamond body 310 and into the monolithic diamond body 310.

The electrodes (e.g., the first and second electrodes 120, 130) may have, or include, any suitable form. Suitable electrode forms may be characterized as having one or more capacitive interface regions (e.g., a surface, a face, or an axis) suitable to each be separated from capacitive interface regions of one or more opposing electrodes by a dielectric diamond layer (e.g., the dielectric diamond layer 114). For example, as shown in FIG. 1, the cross-section of the first electrode 120 defines a capacitive interface region 124 separated from the capacitive interface region of the opposing electrode (i.e., the capacitive interface region 134 of the second electrode 130) by the dielectric diamond layer 114. Similarly, the cross-section of the second electrode 130 defines the capacitive interface region 134 separated from the capacitive interface region of the opposing electrode (i.e., the capacitive interface region 124 of the first electrode 120) by the dielectric diamond layer 114.

The capacitive interface region(s) of each electrode (e.g., the capacitive interface regions 124, 134) may have any suitable surface area. Suitable capacitive interface region surface areas may be selected based on factors such as a desired energy density (for example, an interface region with a higher surface area may generally provide higher energy density), and desired capacitance (which may likewise be improved by a higher surface area), a dielectric constant of the diamond dielectric layer, or a thickness of the dielectric diamond layer (i.e., the distance between two capacitive interface regions, measured, for example, perpendicular to a plane defined by one or both of the two capacitive interface regions). As another example, suitable capacitive interface region surface areas may be selected based on a desired shape for the capacitor form factor.

In some embodiments, suitable electrode forms may include a plate, which may be described as defining a plane. Additionally or alternatively, suitable electrode forms may include a rod form, a cylindrical form, a tubular form, a conical form, a frustoconical form, a prismatic form, a torus form, or any combination thereof. Suitable electrode forms may additionally or alternatively include cross-sectional profiles, such as planar profiles, non-planar profiles, geometric profiles, non-geometric profiles, undulating profiles, wavy profiles, or curved profiles. It will be understood in light of the present disclosure that any suitable electrode form may be used and the disclosure is not limited in this regard.

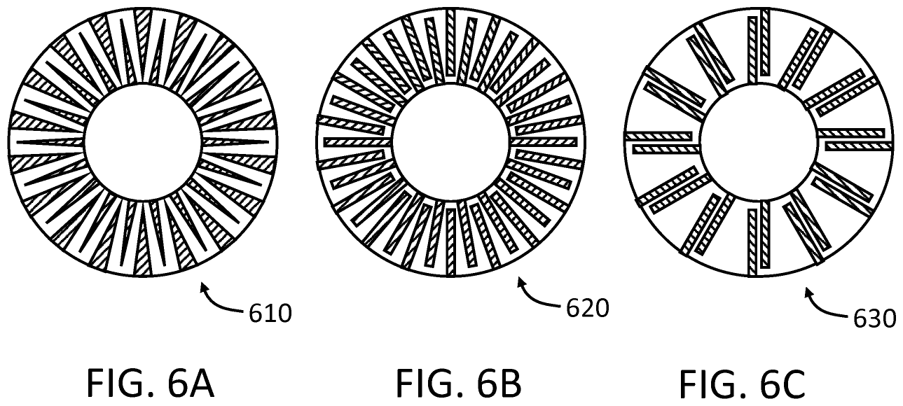

In one or more embodiments, the capacitor may include electrodes having a plate (i.e., plane) form, as shown in FIG. 3B, as an example. In particular embodiments, the first electrode (for example, one or more of the plurality of first electrodes 320) may define a first electrode plane parallel to a second electrode plane defined by the second electrode (for example, one or more of the plurality of respective second electrodes 330). In other words, the plane defined by the first electrode may be parallel to the plane defined by the opposing (i.e., adjacent) second electrode. Additionally or alternatively, the first electrode plane defined by the first electrode may be non-parallel to the second electrode plane defined by the second electrode (see FIG. 6B, for example).

In some embodiments, a first electrode of one unit cell (e.g., a first unit cell) of the plurality of unit cells may define a plane non-parallel to a plane defined by a first electrode of another unit cell (e.g., a second unit cell) of the plurality of unit cells (see FIG. 6B and FIG. 6C, as examples).

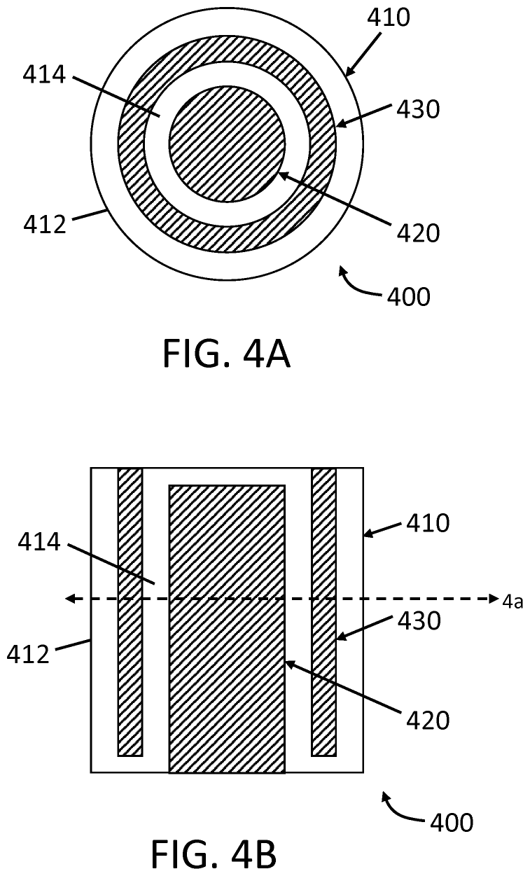

In one or more embodiments, the cross-sectional shape of one or both of the first and second electrodes may each form, or define, a ring. In embodiments having ring-shaped electrodes, the electrodes may be concentric. An illustrative embodiment of a capacitor 400 with a ring-shaped electrode concentric to a cylindrical electrode is shown in FIGS. 4A and 4B. The capacitor 400 may include a first electrode 420 having a cylindrical form and a second electrode 430 having a tubular form. Such an embodiment may include a tubular diamond dielectric region 414. In some embodiments, the first electrode 420 may additionally or alternatively have a tubular form. In such embodiments, for example, the first and second electrodes may form concentric rings or concentric tubular forms.

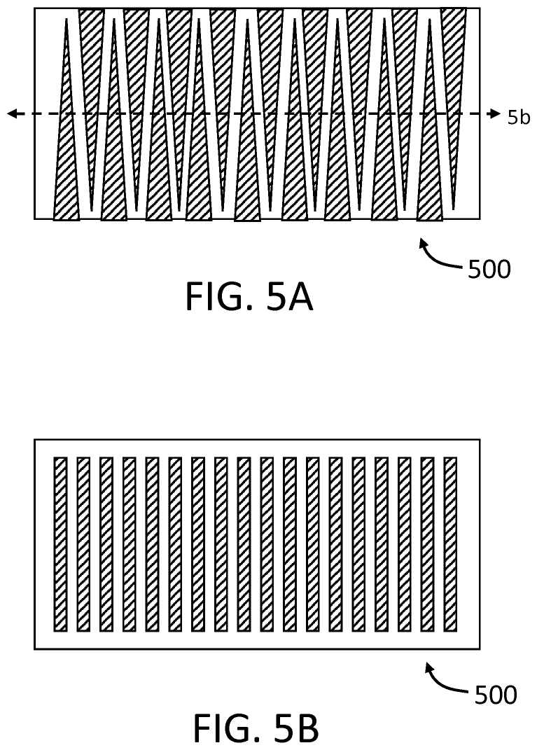

Yet another illustrative embodiment of a capacitor 500 is shown in cross-section side view in FIG. 5A and in cross-section top view in FIG. 5B. The capacitor 500 includes first electrodes and second electrodes, each having a wedge form (i.e., a triangular prism form or a tapered form). Embodiments including electrodes having a wedge form may be useful, for example, to reduce resistance in the electrodes.

Each electrode (e.g., the first and second electrodes 120, 130) may have any suitable thickness. The thickness of an electrode may be described as a dimension of the electrode measured perpendicular to a plane defined by the electrode. Suitable electrode thicknesses may be selected based on factors such as a desired conductivity (for example, a thicker electrode may provide greater conductivity compared to a thinner electrode), a speed of manufacturing to form each electrode (for example, a thicker electrode may take longer to form compared to a thinner electrode), and mechanical stresses (e.g., on the monolithic diamond substrate, the dielectric diamond layer, adjacent/proximate electrodes, etc.), as a few examples. Suitable electrode thicknesses may be, or include, for example, 250 nanometers (nm) to 2 micrometers (um). As further examples, suitable electrode thicknesses may be, or include, 200 nm or greater, 400 nm or greater, 0.5 um or greater, 0.8 um or greater, 1 um or greater, 1.5 um or greater, 3 um or greater, or 5 um or greater, and/or 10 um or less, 7 um or less, 5 um or less, 3 um or less, 1 um or less, or 0.5 um or less. In a particular embodiment, the electrode thickness is about 1 um. It will be understood in light of the present disclosure that any suitable electrode thickness may be used and the disclosure is not limited in this regard.

The electrode contact region (e.g., the first and second electrode contact regions 122, 132) may be described as providing electrical connection between a respective electrode (e.g., the first or second electrode 120, 130) and the environment outside the monolithic diamond body (e.g., an exterior environment outside the monolithic diamond body 110). As an example, the first electrode contact region 122 may provide electrical connection between the first electrode 120 and the exterior environment. As another example, the second electrode contact region 132 may provide electrical connection between the second electrode 130 and the exterior environment. Each electrode contact region may additionally or alternatively be described as a portion of the respective electrode at the outer surface of the monolithic diamond body.

Each electrode contact region may have any suitable form. Suitable electrode contact region forms may include a rectangular form, a rod form, a cylindrical form, a tubular form, a conical form, a frustoconical form, a prismatic form, a torus form, and any combinations thereof. It will be understood in light of the present disclosure that any suitable electrode contact region form may be used and the disclosure is not limited in this regard.

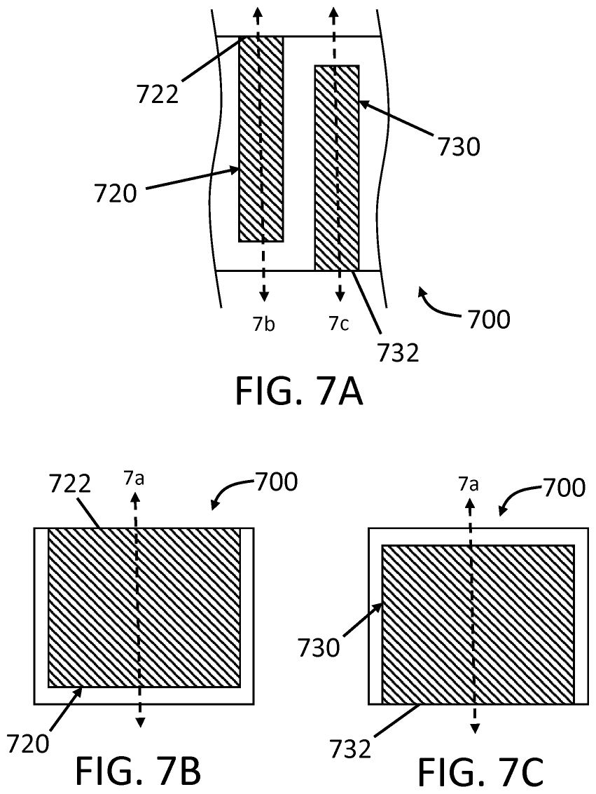

In one or more embodiments, each electrode contact region may have a width that is less than or equal to a width of the respective electrode. In some embodiments, each electrode contact region may have a width that is greater than a width of the respective electrode. An illustrative capacitor 700 having electrode contact regions with widths equal to widths of the respective electrodes is shown in cross-section side view in FIG. 7A.

A front view of the capacitor 700 showing a cross-section (along axis 7b) through a first electrode 720 is shown in FIG. 7B. In embodiments consistent with aspects of FIG. 7B, a first electrode contact region 722 may have a width approximately equal to a width of the first electrode 720. A front view of the capacitor 700 showing a cross-section (along axis 7c of FIG. 7A) through a second electrode 730 is shown in FIG. 7C. In embodiments consistent with aspects of FIG. 7C, a second electrode contact region 732 may have a width approximately equal to a width of the second electrode 730.

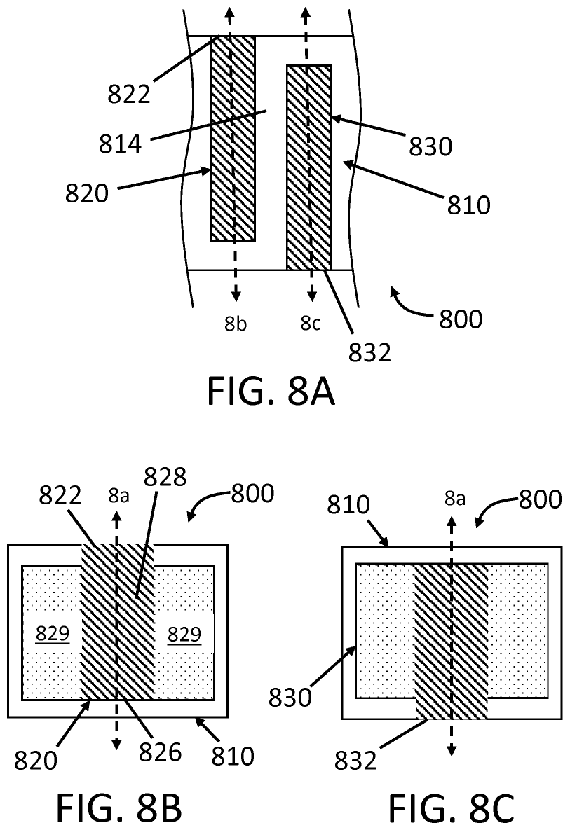

Another illustrative capacitor 800 is shown in cross-section side view in FIG. 8A, the capacitor 800 having electrode contact regions 822, 832 with widths less than widths of the respective electrodes 820, 830.

A front view of the capacitor 800 showing a cross-section (along axis 8b of FIG. 8A) through the first electrode 820 is shown in FIG. 8B. In embodiments consistent with aspects of FIG. 8B, the first electrode contact region 822 may have a width less than a width of the first electrode 820. A front view of the capacitor 800 showing a cross-section (along axis 8c of FIG. 8A) through the second electrode 830 is shown in FIG. 8C. In embodiments consistent with aspects of FIG. 8C, the second electrode contact region 832 may have a width approximately equal to a width of the second electrode 830.

As described herein, each electrode may be formed by various combinations of one or more ablated regions defined by the monolithic diamond body with electrically conductive material disposed therein and one or more electrically conductive carbon regions formed in the monolithic diamond body. For example, as shown in FIGS. 8B and 8C, the first electrode 820 may include (e.g., may be formed by) a first ablated region 826 and two electrically conductive carbon regions 829. The first ablated region 826 may be defined by the monolithic diamond body 810 and extend from the first electrode contact region 822 into the monolithic diamond body 810. Each of the electrically conductive carbon regions 829 may be formed in the monolithic diamond body 810 (as described further below) and may be adjacent to and in contact with the first ablated region 826, such that an electrically conductive material 828 disposed in the first ablated region 826 is electrically connected to each of the electrically conductive carbon regions 829.

Each electrode contact region (e.g., the first and second electrode contact regions 122, 132) may be at any suitable surface of the monolithic diamond body. For example, the first and second electrode contact regions 122, 132 may each be at the outer surface of the monolithic diamond body on opposing sides of the monolithic diamond body, such as shown in FIG. 1. As another example, first and second electrode contact regions may be at the outer surface of the monolithic diamond body on the same side of the monolithic diamond body. An illustrative capacitor 900 is shown in cross-section side view in FIG. 9A and in top view in FIG. 9B. In some embodiments, the capacitor 900 includes a first electrode 920 and a second electrode 930. The first electrode 920 may extend from a first electrode contact region 922 at a surface 912 of a monolithic body 910 into the monolithic body 910. The second electrode 930 may extend from a second electrode contact region 932 at the outer surface 912 of the monolithic body 910 into the monolithic body 910. A dielectric diamond layer 914 of the monolithic diamond body may separate the first electrode 920 from the second electrode 930. In embodiments consistent with aspects of FIGS. 9A and 9B, one or both of the electrode contact regions 922, 932 may have a cylindrical form.

It will be understood in light of the present disclosure that the electrode contact regions may be at any suitable outer surface of the monolithic diamond body and the disclosure is not limited in this regard.

A monolithic diamond body (e.g., the monolithic diamond body 110) may be described as a single-crystal diamond or as a bulk, single-crystal diamond. The monolithic diamond body may be lab-grown. Additionally or alternatively, the monolithic diamond body may be naturally formed. The monolithic diamond body may be of any suitable quality. Suitable monolithic diamond body qualities may include industrial grade diamond, for example.

The monolithic diamond body may have, be, or include, any suitable form. Suitable monolithic diamond body forms may include, for example, a rectangular cross-section, as shown in FIG. 1. Suitable forms may additionally or alternatively include a toric cross-section. Illustrative capacitors 610, 620, 630 having toric cross-sections are shown in cross-section top view in FIGS. 6A-6C. Further examples of suitable forms may include, but are not limited to, cubic forms, rectangular prism forms, spheric forms, cylindrical forms, toric forms, ring forms, bar forms, rod forms, polygonal forms, or any combination thereof. It will be understood in light of the present disclosure that any suitable monolithic diamond body form may be used, and the disclosure is not limited in this regard.

The monolithic diamond body may have any suitable dimensions. The monolithic diamond body may have a width of 2 centimeters (cm) to 6 cm and a thickness of 0.1 cm to 0.5 cm, as an example. It will be understood in light of the present disclosure that any suitable monolithic diamond body dimensions may be used and the disclosure is not limited in this regard.

In some embodiments, suitable monolithic diamond body dimensions include a width. The monolithic diamond body may have any suitable width. Suitable widths may include, for example, 1 cm to 10 cm. As further examples, suitable widths may include 0.5 cm or greater, 1 cm or greater, 2 cm or greater, 5 cm or greater, 8 cm or greater, or 10 cm or greater and/or 15 cm or less, 12 cm or less, 10 cm or less, 8 cm or less, 5 cm or less, 3 cm or less, or 1 cm or less. In a particular embodiment, the monolithic diamond body width is 4 cm. It will be understood in light of the present disclosure that any suitable monolithic diamond body width may be used, and the disclosure is not limited in this regard.

In one or more embodiments, suitable monolithic diamond body dimensions include a height. The monolithic diamond body may have any suitable height. Suitable heights may include, for example, 0.05 cm to 1 cm. As further examples, suitable heights may include 0.05 cm or greater, 0.1 cm or greater, 0.2 cm or greater, 0.5 cm or greater, 0.8 cm or greater, or 1 cm or greater and/or 1.5 cm or less, 1.2 cm or less, 1 cm or less, 0.8 cm or less, 0.5 cm or less, 0.3 cm or less, or 0.1 cm or less. In a particular embodiment, the monolithic diamond body height is 0.3 cm. It will be understood in light of the present disclosure that any suitable monolithic diamond body height may be used, and the disclosure is not limited in this regard.

In at least one embodiment, suitable monolithic diamond body dimensions include a depth. The monolithic diamond body may have any suitable depth. Suitable depths may include, for example, 0.5 cm to 5 cm. As further examples, suitable depths may include 0.5 cm or greater, 1 cm or greater, 2 cm or greater, 5 cm or greater, or 8 cm or greater, and/or 10 cm or less, 7 cm or less, 5 cm or less, 3 cm or less, 2 cm or less, 1 cm or less, or 0.5 cm or less. In a particular embodiment, the monolithic diamond body depth is 2 cm. It will be understood in light of the present disclosure that any suitable monolithic diamond body depth may be used, and the disclosure is not limited in this regard.

The monolithic diamond body may have any suitable volume. Suitable volumes may include, for example, 0.1 cubic centimeters (cc) to 10 cc. As further examples, suitable volumes may include 0.1 cc or greater, 1 cc or greater, 3 cc or greater, 5 cc or greater, 8 cc or greater, or 10 cc or greater and/or 15 cc or less, 12 cc or less, 8 cc or less, 6 cc or less, 3 cc or less, 1 cc or less, or 0.5 cc or less. In a particular embodiment, the monolithic diamond body volume is 2 cc. It will be understood in light of the present disclosure that any suitable monolithic diamond body volume may be used and the disclosure is not limited in this regard.

Illustrative capacitors, as described herein, may include one or more dielectric diamond layers (e.g., the dielectric diamond layer 114). Each dielectric diamond layer may have any suitable breakdown voltage. Suitable dielectric diamond layer breakdown voltages may be, or include, 10 to 100 megavolts per centimeter (MV/cm), as an example. As further examples, the dielectric diamond layer breakdown voltage may be, or include 10 MV/cm or greater, 20 MV/cm or greater, 35 MV/cm or greater, 50 MV/cm or greater, 80 MV/cm or greater, or 100 MV/cm or greater and/or 120 MV/cm or less, 100 MV/cm or less, 80 MV/cm or less, 65 MV/cm or less, 50 MV/cm or less, or 140 MV/cm or less. In a particular embodiment, the dielectric diamond layer breakdown voltage is 30 MV/cm. It will be understood in light of the present disclosure that any suitable dielectric diamond layer breakdown voltage may be used and the disclosure is not limited in this regard.

Each dielectric diamond layer may have any suitable dielectric constant. Suitable dielectric diamond layer dielectric constants may be, or include 4 to 10, as an example. As further examples, the dielectric diamond layer dielectric constant may be, or include 4 or greater, 5 or greater, 6 or greater, 7 or greater, 8 or greater, or 9 or greater and/or 10 or less, 9 or less, 8 or less, 7 or less, 6 or less, or 4 or less. In a particular embodiment, the dielectric diamond layer dielectric constant is 5.5. It will be understood in light of the present disclosure that any suitable dielectric diamond layer dielectric constant may be used and the disclosure is not limited in this regard.

Each dielectric diamond layer may have any suitable thickness. Suitable dielectric diamond layer thicknesses may be selected based on factors such as a desired energy density (which may be increased, for example, by minimizing thickness of the dielectric diamond layer), a desired durability (which may be reduced, for example, with lower thickness of the dielectric diamond layer), and a dielectric constant of the dielectric diamond layer, as a few examples. Suitable dielectric diamond layer thicknesses may be, or include, 250 nm to 2 um, as an example. As further examples, suitable dielectric diamond layer thicknesses may be, or include, 0.25 um or greater, 0.5 um or greater, 0.8 um or greater, 1 um or greater, 1.5 um or greater, 3 um or greater, or 5 um or greater and/or 10 um or less, 7 um or less, 5 um or less, 3 um or less, 1 um or less, or 0.5 um or less. In a particular embodiment, the dielectric diamond layer thickness is 1 um. It will be understood in light of the present disclosure that any suitable dielectric diamond layer thickness may be used and the disclosure is not limited in this regard.

In some embodiments, each dielectric diamond layer has a consistent thickness across the surface area of the dielectric diamond layer (as shown, e.g., in FIGS. 3B, 5A, and 5B). Additionally or alternatively, the dielectric diamond layer may have uneven (e.g., tapered) thickness across the surface area of the dielectric diamond layer (as shown, e.g., in FIG. 6B).

In one or more embodiments, the illustrative capacitors described herein include one or more electrode connectors, such as a first electrode connector, which may electrically connect at least two first electrodes of the plurality of capacitor unit cells (e.g., at least two of the first electrodes 320). The capacitor may further include a second electrode connector, which may electrically connect at least two second electrodes of the plurality of capacitor unit cells (e.g., at least two of the second electrodes 330). The first and second electrode connectors may each be electrically connectable to a power source (such as a battery or another capacitor, as just two examples) for transfer of energy from the power source to the capacitor. Additionally or alternatively, the first and second electrode connectors may each be electrically connectable to a device (such as the leads of a medical device, for example) for transfer of energy from the capacitor to the device.

Each electrode connector may include any suitable material. Suitable electrode connector materials may be selected based on conductivity of the material, a desired method of assembly, and a material compatibility (such as between the electrode connector and the electrode or between the electrode connector and the monolithic diamond substrate), as a few examples. As another example, suitable materials may be selected based on compatibility of the material with the electrically conductive material of the electrodes. Compatibility may include factors such as contact resistance between the electrode connector material and the electrically conductive material of the electrode or adhesion between the electrode connector material and the electrically conductive material of the electrode. Examples of suitable electrode connector materials may include a metal, a conductive resin, a conductive epoxy (such as an epoxy impregnated with silver), a conductive polymer, and any combination thereof. As further examples, suitable electrode connector materials may include aluminum, copper, silver, gold, platinum, or any combination (e.g., alloy) thereof. As still further examples, suitable electrode connector materials may include a simple metal layer, sputtered metal, solder balls, and any combination thereof. It will be understood in light of the present disclosure that any suitable electrode connector materials may be used and the disclosure is not limited in this regard.

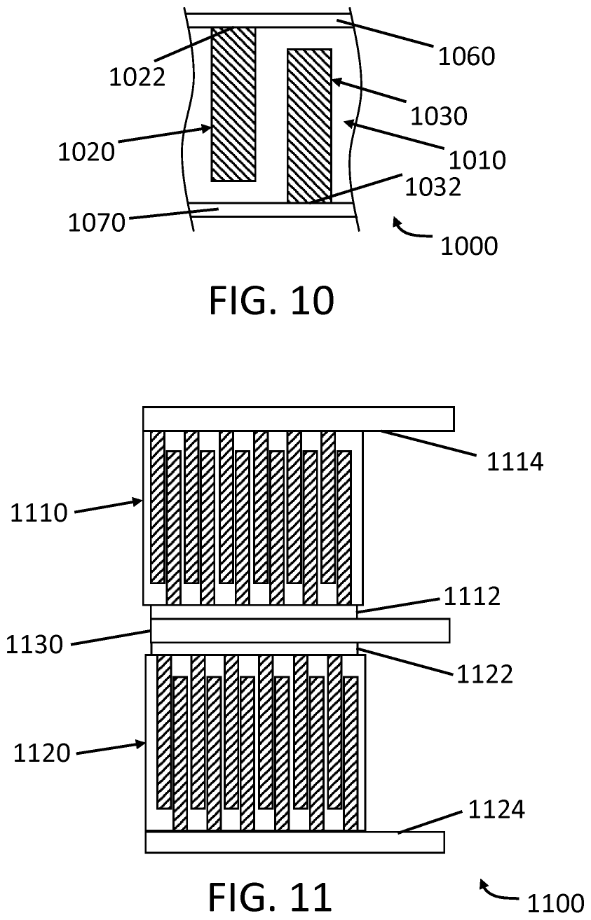

A cross-section side view of an illustrative capacitor 1000 with electrode connectors is shown in FIG. 10. The capacitor 1000 may include a plurality of first electrodes 1020 (one shown in FIG. 10), each extending from one of a plurality of first electrode contact regions 1022 (one shown in FIG. 10) at an outer surface of a monolithic diamond body 1010 into the monolithic diamond body 1010. The capacitor 1000 may further include a plurality of second electrodes 1030 (one shown in FIG. 10), each extending from one of a plurality of second electrode contact regions 1032 (one shown in FIG. 10) at the outer surface of the monolithic diamond body 1010 into the monolithic diamond body 1010. Embodiments consistent with aspects of the capacitor 1000 may include a first electrode connector 1060 and may further include a second electrode connector 1070. The first electrode connector 1060 may be electrically connectable to at least one of the plurality of first electrodes 1020 via the first electrode contact region 1022 of the respective first electrode 1020. The second electrode connector 1070 may be electrically connectable to at least one of the plurality of second electrodes 1030 via the second electrode contact region 1032 of the respective second electrode 1030.

In one or more embodiments, the first electrode connector 1060 is electrically connectable (e.g., electrically connected) to an electrode connector of another capacitor (e.g., a first electrode connector of a second capacitor). Likewise, the second electrode connector 1070 may be electrically connectable to an electrode connector of another capacitor (e.g., a second electrode connector of a third capacitor). That is to say, one or more, two or more, three or more, or four or more capacitors may be electrically connectable (e.g., electrically connected) via their respective first and second electrode connectors. For example, a plurality of capacitors may be electrically connectable in parallel, in series, or any combination thereof.

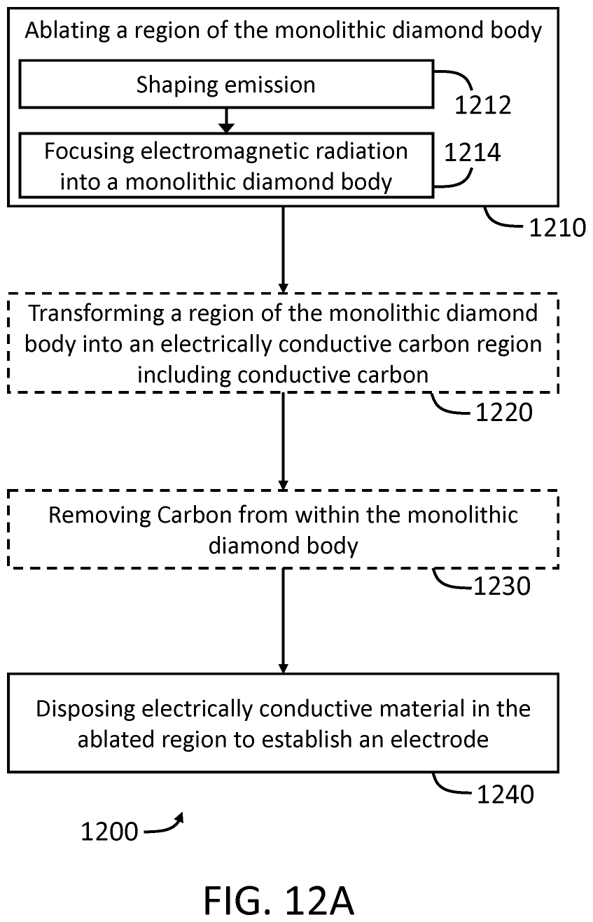

A cross-section side view of an illustrative assembly 1100 of two capacitors is shown in FIG. 11. The assembly 1100 may include a first capacitor 1110 including a first monolithic diamond body and a second capacitor 1120 including a second monolithic diamond body. The first capacitor 1110 may have one or both of a first electrode connector 1112 and a second electrode connector 1114. Similarly, the second capacitor 1120 may have one or both of a first electrode connector 1122 and a second electrode connector 1124. The first electrode connector 1112 of the first capacitor 1110 may be electrically connectable to the first electrode connector 1122 of the second capacitor 1120, for example, via an optional bridge 1130. The bridge 1130 may include any suitable material. Suitable bridge materials may include one or more of the suitable electrode connector materials discussed in the present disclosure. It will be understood in light of the present disclosure that any suitable bridge material may be used and the disclosure is not limited in this regard.

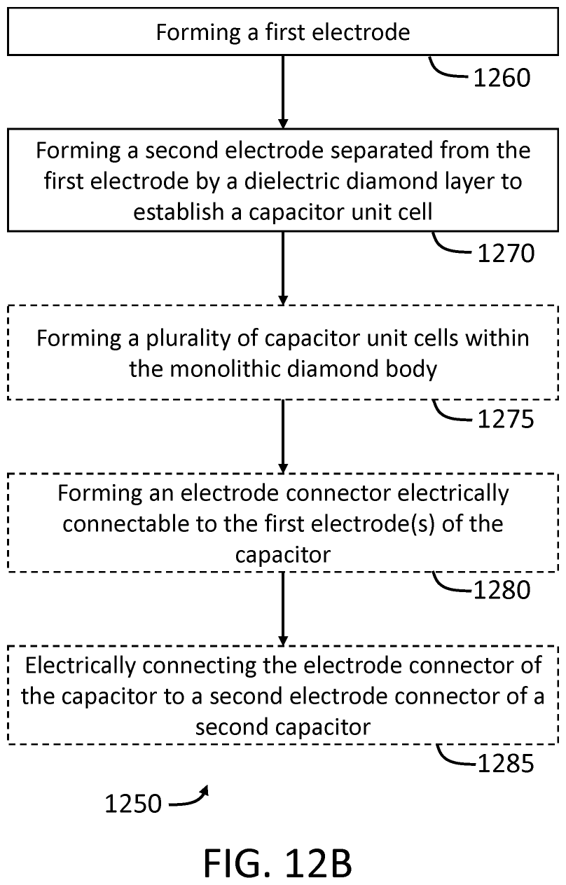

Methods of forming an electrode (e.g., the first electrode 120) within a monolithic diamond substrate are described herein. A flow diagram showing an illustrative method 1200 of forming an electrode within a monolithic diamond body (e.g., as part of an illustrative monolithic diamond capacitor as described herein) is shown in FIG. 12A. It is noted that the operations associated with the methods disclosed herein are not particularly limited to the order reflected in the figures.

In one or more embodiments, the method 1200 includes ablating 1210 a region of the monolithic diamond body, thereby forming an ablated region defined by the monolithic diamond body (e.g., the first ablated region 126 defined by the monolithic diamond body 110). Ablating 1210 may include shaping emission 1212 of electromagnetic radiation and focusing the electromagnetic radiation 1214 into the monolithic diamond body. In some embodiments, focusing the electromagnetic radiation 1214 includes focusing a pulsed laser (e.g., an ultrafast-pulsed laser) into the monolithic diamond body to thereby ablate targeted regions of the diamond substrate.

Ablating the monolithic diamond body (or ablation of the monolithic diamond body) may be described as selectively removing material from the monolithic diamond body, and particularly selective removal of material from the monolithic diamond body by vaporization (e.g., using focused electromagnetic radiation). During ablation, diamond material of the monolithic diamond body may be vaporized, resulting in formation of hot, gaseous carbon (e.g., carbon compounds). In one or more embodiments, the gaseous carbon (e.g., at least a portion of the gaseous carbon) may be removed (e.g., by ejection during the ablation process, by airflow, etc.). In general, ablating 1210 may preferably occur beginning at an outer surface of the monolithic diamond body (e.g., the outer surface 112 of the monolithic diamond body 110).

In one or more embodiments, ablating 1210 may include (e.g., may result in) forming the ablated region starting from an electrode contact region (e.g., the first electrode contact region 122) at the outer surface of the monolithic diamond body and continuing ablation inward (i.e., into the monolithic diamond body). Starting ablation at the outer surface of the monolithic diamond body and continuing ablation inward may advantageously result in ablated material (e.g., vaporized diamond, gaseous carbon, etc.) being removed (e.g., ejected) from the monolithic diamond body without the need for additional processing, such as a separate step (e.g., using airflow, suction, etc.) to remove the ablated material.

In some embodiments, the method 1200 includes shaping emission 1212 of electromagnetic radiation, such as a laser beam. Shaping emission 1212 of electromagnetic radiation may create a Gaussian Focus. For example, Gaussian laser pulses may be focused inside the monolithic diamond body, so as to ablate portions of the diamond substrate. A Gaussian focus may be described as exhibiting a relatively shallow axial depth of focus (e.g., approximately the same size as the lateral extent of focus). In other words, a Gaussian focus may be described as having a low aspect ratio. Additionally or alternatively, shaping emission 1212 of electromagnetic radiation may create a Bessel Focus. For example, Bessel laser pulses may be focused inside the monolithic diamond body so as to ablate portions of the diamond substrate. A Bessel focus may be described as exhibiting a relatively deep axial depth of focus (e.g., up to hundreds of times longer than the lateral extent of the focus). In other words, a Bessel focus may be described as forming a cylindrical focal region having a low aspect ratio. Although the rays of the Bessel laser may be described as converging across a wide lateral extent, the energy intensity may be described as reaching the threshold for ablating the diamond substrate only in the centermost 1-2 microns of the overlap region, thereby forming, for example, the cylindrical focal region having a low aspect ratio).

In some embodiments, the method 1200 optionally includes transforming 1220 a region of the monolithic diamond body into an electrically conductive region including conductive carbon, for example, by focusing electromagnetic radiation into the monolithic diamond body. Transforming 1220 a region of the monolithic diamond body into an electrically conductive region may include shaping emission of electromagnetic radiation (e.g., to create a Gaussian focus, to create a Bessel focus, etc.) and focusing the electromagnetic radiation into the monolithic diamond body, for example, to transform a region (e.g., a second region that is different than the first region, or the ablated region) of the monolithic diamond body into an electrically conductive region comprising conductive carbon.

In at least one embodiment, the method 1200 of forming an electrode within a monolithic diamond body optionally includes removing carbon 1230 (e.g., removing electrically conductive carbon) from a region of the monolithic diamond body. Removing carbon 1230 may occur using any suitable technique. Suitable carbon removal techniques may include, for example, electrochemical oxidation.

In one or more embodiments, removing carbon 1230 includes removing electrically conductive carbon from an electrically conductive region. In such embodiments, removing the electrically conductive carbon may be described as forming an ablated region (e.g., the first ablated region 126). Similarly, in some embodiments, forming an ablated region may include transforming a region of the monolithic diamond body into a carbon region (e.g., an electrically conductive carbon region) and then removing the carbon.

In some embodiments, removing carbon 1230 includes removing carbon from an ablated region (e.g., the first ablated region 126). As described herein, removal of ablated material (e.g., at least a portion of the ablated material) from the monolithic diamond body may occur as part of the ablation step, such as where gaseous carbon is ejected during ablating 1210. Conversely, gaseous carbon (e.g., at least a portion of the gaseous carbon) may be redeposited on the monolithic diamond body, such as on an inner surface of the ablated region. Such redeposition may occur, for example, where gaseous carbon that is within an ablated region defined by the monolithic diamond body lowers in temperature to below its boiling point, thereby forming non-gaseous carbon (e.g., particles of solid carbon compounds, droplets of liquid carbon compounds, etc.). In other words, such redeposition may occur when ablated material is not sufficiently energetic to eject from the ablated region (e.g., to the exterior environment outside the monolithic diamond body). The likelihood or extent of redeposition may be affected by factors such as the depth of ablation (i.e., how far within the monolithic diamond body the ablated region extends), the tortuosity of the path for the ablated material to escape, the dimensions (e.g., size) of an opening between the ablated region defined by the monolithic diamond body and an exterior environment (e.g., the size of the electrode contact region), ambient temperature (e.g., of the diamond monolithic diamond body), amount of energy coupled during ablation, or temperature of gaseous carbon, as examples. In one or more embodiments, redeposited carbon in the ablated region may advantageously wick liquid electrically conductive material (e.g., molten metals) into the ablated region.

In some embodiments, the method 1200 includes disposing 1240 electrically conductive material in the ablated region, thereby forming the electrode within the monolithic diamond body. Disposing 1240 electrically conductive material in the ablated region may occur using any suitable technique. Suitable techniques may be selected based on factors such as the dimensions of the ablated region, the tortuosity of the ablated region, material properties of the electrically conductive material, or the degree of carbon redeposition in the ablated region, as examples. Suitable techniques may include, for example, sputtering a metal, metal vapor deposition, electroplating, electroless plating, introducing molten metal, atomic layer deposition, or any combination thereof, as examples. It will be understood in view of this disclosure that any suitable techniques for disposing electrically conductive material may be used, and the disclosure is not limited in this regard. It will further be understood in view of this disclosure that suitable techniques for disposing electrically conductive material may be selected and affected based on factors such as those described herein.

Disposing 1240 electrically conductive material in the ablated region may include disposing any suitable electrically conductive material. Suitable electrically conductive materials may be selected based on factors described herein.

In one or more embodiments, the method 1200 of forming the electrode includes forming an electrode contact region at an outer surface of the monolithic diamond body. For example, ablating 1210 a region of the monolithic diamond body, thereby forming an ablated region defined by the monolithic diamond body, may include ablating at a surface of the monolithic diamond body to form an ablated electrode contact region at the outer surface of the monolithic diamond body. As another example, disposing 1240 electrically conductive material in the ablated region, thereby forming the electrode within the monolithic diamond body, may include disposing electrically conductive material in the ablated electrode contact region to form an electrode contact region at the outer surface of the monolithic diamond body. The electrode contact region may be adjacent and electrically connected to the electrode.

Methods of forming a diamond capacitor (e.g., the capacitor 100) using a monolithic diamond substrate by forming electrodes (e.g., the first electrode 120) within the diamond substrate are described herein. A flow diagram showing an illustrative method 1250 of forming a capacitor is shown in FIG. 12B.

In some embodiments, the method 1250 includes forming 1260 a first electrode (e.g., the first electrode 120, the first electrodes 320, etc.) within a monolithic diamond body (e.g., the monolithic diamond body 110, the monolithic diamond body 310, etc.). Forming 1260 the first electrode may include one or more aspects (e.g., one or more steps) of the method 1200 of forming an electrode within a monolithic diamond body, as described herein. For example, forming 1260 the first electrode may include ablating (e.g., ablating 1210) a region of the monolithic diamond body, thereby forming an ablated region defined by the monolithic diamond body, and disposing (e.g., disposing 1240) electrically conductive material in the ablated region, thereby forming 1260 the first electrode within the monolithic diamond body.

In one or more embodiments, the method 1250 includes forming 1270 a second electrode (e.g., the second electrode 130, the second electrodes 330, etc.) within the monolithic diamond body. The second electrode may be formed, for example, using one or more aspects (e.g., one or more steps) of the method 1200 of forming an electrode within a monolithic diamond body. For example, forming 1270 the second electrode may include ablating (e.g., ablating 1210) a region of the monolithic diamond body, thereby forming an ablated region defined by the monolithic diamond body, and disposing (e.g., disposing 1240) electrically conductive material in the ablated region, thereby forming 1270 the second electrode within the monolithic diamond body.

In at least one embodiment, forming 1270 the second electrode includes forming the second electrode separated from the first electrode by a dielectric diamond layer (e.g., the dielectric diamond layer 114, the dielectric diamond layers 314, etc.) of the monolithic diamond body, as described herein. Forming 1270 the second electrode may occur using the same techniques (e.g., steps) as forming 1260 the first electrode. In some embodiments, forming 1260 the first electrode and forming 1270 the second electrode occur using different techniques (e.g., one or more steps used to form the second electrode may be different than the steps used to form the first electrode). Forming 1260 the first electrode and forming 1270 the second electrode may be described as establishing a capacitor unit cell including the dielectric diamond layer separating the formed first and second electrodes.

In some embodiments, the method 1250 optionally includes forming 1275 a plurality of capacitor unit cells within the monolithic diamond body. Forming 1275 the plurality of capacitor unit cells within the monolithic diamond body may include forming interdigitated first and second electrodes within the monolithic diamond body (e.g., the interdigitated first electrodes 320 and second electrodes 330).

In some embodiments, the method 1250 optionally includes forming 1280 an electrode connector electrically connectable (e.g., electrically connected) to the first electrode of at least one of the plurality of capacitor unit cells. Forming 1280 the electrode connector may occur using any suitable techniques. Suitable techniques for forming 1280 the electrode connector may include, for example, applying a photolithographic mask on a surface of the monolithic diamond body.

In one or more embodiments, the method 1250 optionally includes electrically connecting 1285 the electrode connector of the capacitor to a second electrode connector of a second capacitor.

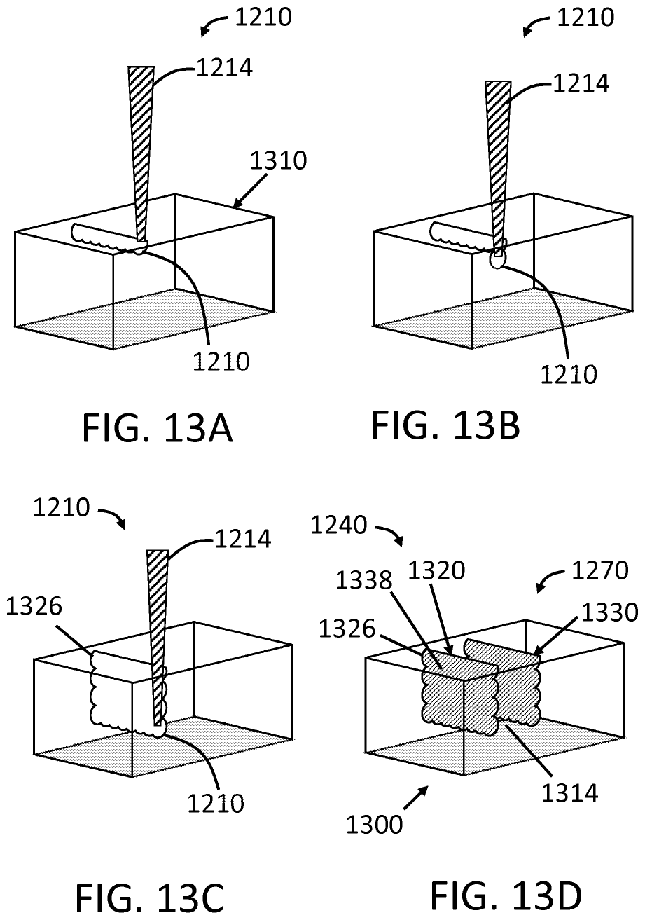

A diagram illustrating aspects of the method 1200 of making an electrode and aspects of the method 1250 of making a capacitor according to the present disclosure is shown in FIGS. 13A-13D. As described herein, the method 1200 of making the electrode may include ablating 1210 a region of a monolithic diamond body 1310, which may include focusing electromagnetic radiation 1214 into the monolithic diamond body 1310. Ablating 1210 the monolithic diamond body 1310 may include starting from an outer surface of the monolithic diamond body 1310 (as shown in FIG. 13A) and continuing ablation inward (as shown in FIGS. 13B and 13C). Ablating 1210 may include forming an ablated region 1326, as shown in FIG. 13C. As described herein, the method 1200 of making the electrode may include disposing 1240 electrically conductive material in the ablated region 1326 to thereby form an electrode. For example, as shown in FIG. 13D, the method 1200 may include disposing 1240 electrically conductive material 1338 in the ablated region 1326, thereby forming a first electrode 1320.

As described herein, the method 1250 of making a capacitor may include forming 1260 a first electrode (e.g., the first electrode 1320) and forming 1270 a second electrode (e.g., a second electrode 1330) separated from the first electrode 1320 by a dielectric diamond layer 1314, as shown in FIG. 13D. Forming 1270 the second electrode 1330 may establish a capacitor unit cell of a capacitor 1300. As described herein, the method 1250 may further include forming a plurality of capacitor unit cells within the monolithic diamond body (not shown in FIGS. 13A-13D).

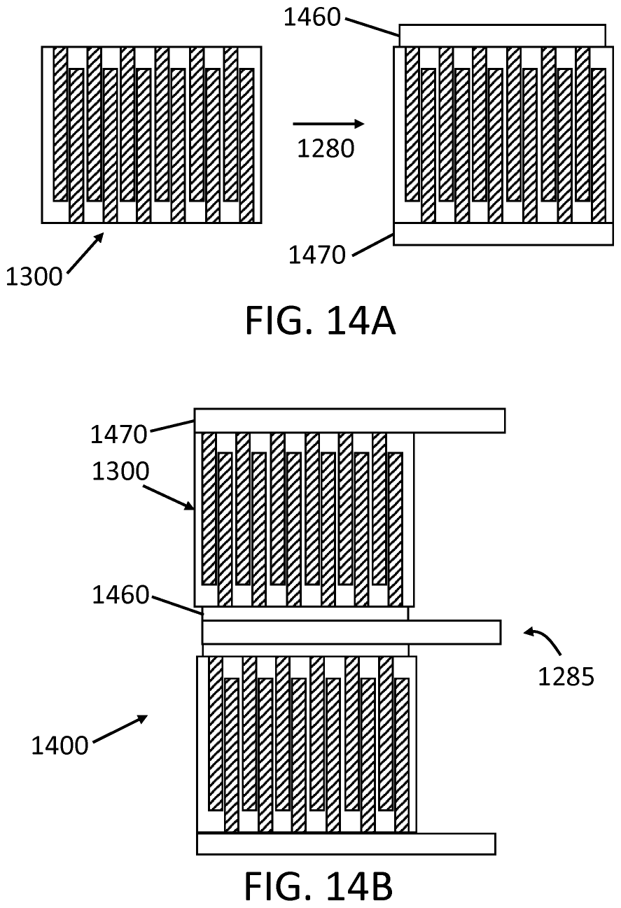

A diagram illustrating further aspects of the method 1250 of making a capacitor according to the present disclosure is shown in FIGS. 14A and 14B. As described herein, the method 1250 may include forming 1280 an electrode connector 1460 electrically connectable (e.g., electrically connected) to a first electrode (e.g., the first electrode 1320) of at least one of the plurality of capacitor unit cells. Forming 1280 the electrode connector 1460 may occur using any suitable technique. As just one example, forming 1280 the electrode connector 1460 may include sputtering a metal. The method 1250 may further include forming a second electrode connector 1470 electrically connectable to a second electrode (e.g., the second electrode 1330) of at least one of the plurality of capacitor unit cells. As described herein, the method 1250 may still further include electrically connecting 1285 the electrode connector 1460 of the capacitor 1300 to a second electrode connector of a second capacitor, thereby forming a capacitor assembly 1400.

### Illustrative Aspects

The following is a list of illustrative embodiments according to the present disclosure.

Aspect 1 is a capacitor comprising a monolithic diamond body; a first electrode comprising electrically conductive material disposed within a first ablated region defined by the monolithic diamond body and extending from a first electrode contact region at an outer surface of the monolithic diamond body into the monolithic diamond body; a second electrode comprising electrically conductive material, the second electrode extending from a second electrode contact region at the outer surface of the monolithic diamond body into the monolithic diamond body; and a dielectric diamond layer of the monolithic diamond body separating the first electrode and the second electrode.

Aspect 2 is the capacitor according to aspect 1, wherein the electrically conductive material of the second electrode is disposed within a second ablated region defined by the monolithic diamond body and extending from the second electrode contact region at the outer surface of the monolithic diamond body into the monolithic diamond body.

Aspect 3 is the capacitor according to any one of aspects 1 and 2, wherein the electrically conductive material of the first electrode comprises conductive carbon, aluminum, gallium, mercury, copper, silver, gold, titanium, or any combination thereof.

Aspect 4 is the capacitor according to any one of aspects 1-3, wherein the first electrode further comprises an electrically conductive carbon region defined by the monolithic diamond body, the electrically conductive carbon region comprising conductive carbon and electrically connected to the electrically conductive material of the first electrode.

Aspect 5 is the capacitor according to any one of aspects 1-4, wherein one or both of the first and second electrodes each define a plane.

Aspect 6 is the capacitor according to any one of aspects 1-5, wherein the first electrode defines a first electrode plane and the second electrode defines a second electrode plane parallel to the first electrode plane.

Aspect 7 is the capacitor according to aspect 6, wherein the first electrode contact region defines a first electrode contact plane co-planar with the first electrode plane.

Aspect 8 is the capacitor according to any one of aspects 1-7, wherein one or both of the first and second electrodes each defines a ring.

Aspect 9 is the capacitor according to any one of aspects 1-8, wherein the first electrode defines a first electrode ring and the second electrode defines a second electrode ring concentric to the first electrode ring.

Aspect 10 is the capacitor according to any one of aspects 1-9, wherein one or both of the first and second electrodes each defines an axis.

Aspect 11 is the capacitor according to any one of aspects 1-10, wherein the first electrode defines a first electrode axis and the second electrode defines a second electrode axis parallel to the first electrode axis.

Aspect 12 is the capacitor according to aspect 11, wherein the first electrode contact region defines a first electrode contact axis co-axial with the first electrode axis.

Aspect 13 is the capacitor according to any one of aspects 1-12, further comprising: a third electrode comprising electrically conductive material extending from a third electrode contact region at the outer surface of the monolithic diamond body into the monolithic diamond body; a fourth electrode comprising electrically conductive material extending from a fourth electrode contact region at the outer surface of the monolithic diamond body into the monolithic diamond body; and a second dielectric diamond layer of the monolithic diamond body separating the third electrode and the fourth electrode.

Aspect 14 is the capacitor according to aspect 13, wherein the first electrode defines a first electrode plane, and the third electrode defines a third electrode plane parallel to the first electrode plane.

Aspect 15 is the capacitor according to any one of aspects 1-14, wherein the first electrode and the second electrode are of opposite polarities.

Aspect 16 is the capacitor according to any one of aspects 1-15, wherein a width of the first electrode is greater than or equal to a width of the first electrode contact region.

Aspect 17 is the capacitor according to any one of aspects 1-16, wherein a thickness of the dielectric diamond layer is between 250 nanometers and 2 micrometers.

Aspect 18 is the capacitor according to any one of aspects 1-17, wherein a thickness of the first electrode is between 250 nanometers and 2 micrometers.

Aspect 19 is the capacitor according to any one of aspects 1-18, wherein a width of the monolithic diamond body is between 2 centimeters and 6 centimeters, and wherein a thickness of the monolithic diamond body is between 0.1 centimeters and 0.5 centimeters.

Aspect 20 is a capacitor comprising: a monolithic diamond body; and a plurality of capacitor unit cells, each unit cell comprising:
a first electrode comprising electrically conductive material disposed within a first ablated region defined by the monolithic diamond body and extending from a first electrode contact region at an outer surface of the monolithic diamond body into the monolithic diamond body; a second electrode comprising electrically conductive material disposed within a second ablated region defined by the monolithic diamond body and extending from a second electrode contact region at an outer surface of the monolithic diamond body into the monolithic diamond body; and a dielectric diamond layer of the monolithic diamond body separating the first electrode and the second electrode.

Aspect 21 is the capacitor according to aspect 20, wherein the electrically conductive material of the first electrode comprises conductive carbon, aluminum, gallium, mercury, copper, silver, gold, titanium, or any combination thereof.

Aspect 22 is the capacitor according to any one of aspects 20 and 21, wherein the first electrode of at least one of the plurality of capacitor unit cells further comprises an electrically conductive carbon region defined by the monolithic diamond body, the electrically conductive carbon region comprising conductive carbon and electrically connected to the electrically conductive material of the respective first electrode.

Aspect 23 is the capacitor according to any one of aspects 20-22, wherein the first electrode of at least one of the plurality of capacitor unit cells is the second electrode of another one of the plurality of capacitor unit cells.

Aspect 24 is the capacitor according to any one of aspects 20-23, further comprising a first electrode connector electrically connecting at least two first electrodes of the plurality of capacitor unit cells.

Aspect 25 is the capacitor according to aspect 24, wherein the first electrode connector is electrically connectable to a first electrode connector of a second capacitor comprising a second monolithic diamond body.

Aspect 26 is the capacitor according to any one of aspects 24 and 25, wherein the first electrode connector comprises a simple metal layer, sputtered metal, solder balls, or a combination of two or more thereof.

Aspect 27 is the capacitor according to any one of aspects 24-26, wherein the first electrode connector comprises one or both of a metal and a conductive resin.

Aspect 28 is a method for manufacturing a capacitor, the method comprising:
forming a first electrode within a monolithic diamond body, forming the first electrode comprising: focusing electromagnetic radiation into the monolithic diamond body to ablate a region of the monolithic diamond body, thereby forming a first ablated region defined by the monolithic diamond body; and disposing electrically conductive material in the first ablated region; and
forming a second electrode within the monolithic diamond body, the second electrode separated from the first electrode by a dielectric diamond layer of the monolithic diamond body.

Aspect 29 is the method according to aspect 28, wherein forming the first electrode further comprises focusing electromagnetic radiation into the monolithic diamond body to transform a second region of the monolithic diamond body into an electrically conductive carbon region defined by the monolithic diamond body, the electrically conductive carbon region comprising conductive carbon.

Aspect 30 is the method according to any one of aspects 28 and 29, wherein the electrically conductive material comprises conductive carbon, aluminum, gallium, mercury, copper, silver, gold, titanium, or any combination thereof.

Aspect 31 is the method according to any one of aspects 28-30, wherein disposing electrically conductive material in the first ablated region comprises sputtering a metal, metal vapor deposition, introducing molten metal, electroplating, electroless plating, or any combination thereof.

Aspect 32 is the method according to any one of aspects 28-31, wherein forming the first electrode further comprises removing carbon from within the first ablated region.

Aspect 33 is the method according to any one of aspects 28-32, wherein forming the first electrode and forming the second electrode establishes a capacitor unit cell, the method further comprising forming a plurality of capacitor unit cells within the monolithic diamond body.

Aspect 34 is the method according to any one of aspects 28 to 33, wherein focusing electromagnetic radiation into the monolithic diamond body comprises shaping a laser beam to create a Bessel focus, shaping a laser to create a Gaussian focus, or any combination thereof.

Aspect 35 is the method according to any one of aspects 28-34, wherein focusing electromagnetic radiation into the monolithic diamond body comprises focusing pulsed electromagnetic radiation into the monolithic diamond body.

Aspect 36 is the method according to any one of aspects 28-35, wherein focusing electromagnetic radiation into the monolithic diamond body to ablate the region of the monolithic diamond body, thereby forming the first ablated region defined by the monolithic diamond body comprises forming a first ablated electrode contact region at a surface of the monolithic diamond body; wherein disposing electrically conductive material in the first ablated region comprises disposing electrically conductive material in the first ablated electrode contact region, thereby forming a first electrode contact region; and wherein the first electrode contact region is adjacent and electrically connected to the first electrode.

Aspect 37 is the method according to any one of aspects 28-36, further comprising forming an electrode connector electrically connected to the first electrode.

Aspect 38 is the method according to aspect 37, wherein the electrode connector comprises one or both of a metal and a conductive resin.

Aspect 39 is the method according to any one of aspects 37 and 38, wherein forming an electrode connector comprises sputtering a metal.

Aspect 40 is the method according to any one of aspects 37-39, wherein forming an electrode connector comprises applying a photolithographic mask on a surface of the monolithic diamond body.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application were specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A capacitor comprising:
a monolithic diamond body;
a first electrode comprising electrically conductive material disposed within a first ablated region defined by the monolithic diamond body and extending from a first electrode contact region at an outer surface of the monolithic diamond body into the monolithic diamond body;
a second electrode comprising electrically conductive material, the second electrode extending from a second electrode contact region at the outer surface of the monolithic diamond body into the monolithic diamond body; and
a dielectric diamond layer of the monolithic diamond body separating the first electrode and the second electrode.

2. The capacitor according to claim 1, wherein the electrically conductive material of the second electrode is disposed within a second ablated region defined by the monolithic diamond body and extending from the second electrode contact region at the outer surface of the monolithic diamond body into the monolithic diamond body.

3. The capacitor according to claim 1, wherein the electrically conductive material of the first electrode comprises conductive carbon, aluminum, gallium, mercury, copper, silver, gold, titanium, or any combination thereof.

4. The capacitor according to claim 1, wherein the first electrode further comprises an electrically conductive carbon region defined by the monolithic diamond body, the electrically conductive carbon region comprising conductive carbon and electrically connected to the electrically conductive material of the first electrode.

5. The capacitor according to claim 1, wherein one or both of the first and second electrodes each define a plane.

6. The capacitor according to claim 1, wherein one or both of the first and second electrodes each define a ring.

7. The capacitor according to claim 1, wherein one or both of the first and second electrodes each define an axis.

8. The capacitor according to claim 1, further comprising:
a third electrode comprising electrically conductive material extending from a third electrode contact region at the outer surface of the monolithic diamond body into the monolithic diamond body;
a fourth electrode comprising electrically conductive material extending from a fourth electrode contact region at the outer surface of the monolithic diamond body into the monolithic diamond body; and
a second dielectric diamond layer of the monolithic diamond body separating the third electrode and the fourth electrode.

9. The capacitor according to claim 1, wherein a thickness of the dielectric diamond layer is between 250 nanometers and 2 micrometers.

10. The capacitor according to claim 1, wherein a thickness of the first electrode is between 250 nanometers and 2 micrometers.

11. The capacitor according to claim 1, wherein a width of the monolithic diamond body is between 2 centimeters and 6 centimeters and wherein a thickness of the monolithic diamond body is between 0.1 centimeters and 0.5 centimeters.

12. A capacitor comprising:
a monolithic diamond body; and
a plurality of capacitor unit cells, each unit cell comprising:
a first electrode comprising electrically conductive material disposed within a first ablated region defined by the monolithic diamond body and extending from a first electrode contact region at an outer surface of the monolithic diamond body into the monolithic diamond body;
a second electrode comprising electrically conductive material disposed within a second ablated region defined by the monolithic diamond body and extending from a second electrode contact region at an outer surface of the monolithic diamond body into the monolithic diamond body; and
a dielectric diamond layer of the monolithic diamond body separating the first electrode and the second electrode.

13. The capacitor according to claim 12, wherein the electrically conductive material of the first electrode comprises conductive carbon, aluminum, gallium, mercury, copper, silver, gold, titanium, or any combination thereof.

14. The capacitor according to claim 12, wherein the first electrode of at least one of the plurality of capacitor unit cells further comprises an electrically conductive carbon region defined by the monolithic diamond body, the electrically conductive carbon region comprising conductive carbon and electrically connected to the electrically conductive material of the respective first electrode.

15. The capacitor according to claim 12, wherein the first electrode of at least one of the plurality of capacitor unit cells is the second electrode of another one of the plurality of capacitor unit cells.

16. The capacitor according to claim 12, further comprising a first electrode connector electrically connecting at least two first electrodes of the plurality of capacitor unit cells.

17. A method for manufacturing a capacitor, the method comprising:
forming a first electrode within a monolithic diamond body, forming the first electrode comprising:
focusing electromagnetic radiation into the monolithic diamond body to ablate a region of the monolithic diamond body, thereby forming a first ablated region defined by the monolithic diamond body; and
disposing electrically conductive material in the first ablated region; and
forming a second electrode within the monolithic diamond body, the second electrode separated from the first electrode by a dielectric diamond layer of the monolithic diamond body.

18. The method according to claim 17, wherein the electrically conductive material comprises conductive carbon, aluminum, gallium, mercury, copper, silver, gold, titanium, or any combination thereof.

19. The method according to claim 17, wherein disposing electrically conductive material in the first ablated region comprises sputtering a metal, metal vapor deposition, introducing molten metal, electroplating, electroless plating, or any combination thereof.

20. The method according to claim 17, wherein forming the first electrode further comprises removing carbon from within the first ablated region.
